(19) United States
(12) Patent Application Publication
(10) Pub. No.: US 2009/0222512 A1
(43) Pub. Date: Sep. 3, 2009

(54) Entryway Communication System

(75) Inventor: David Mohler, Arvada, CO (US)

Correspondence Address: AVAYA INC., 307 MIDDLETOWN-LINCROFT ROAD, ROOM 1N-391, LINCROFT, NJ, 07738, US

(73) Assignee: AVAYA TECHNOLOGY LLC, Basking Ridge, NJ (US)

(21) Appl. No.: 12/041,420

(22) Filed: Mar. 3, 2008

(51) Int. Cl. G06F 15/16

(52) U.S. Cl. 709/203

(57) ABSTRACT

A premises entryway communications device and system enable a visitor to the premises and an occupant of the premises to communicate via icons and text.

### TECHNICAL FIELD

This invention relates to generally to electronic communications systems, and specifically to intercom systems.

### BACKGROUND OF THE INVENTION

A drop-by visitor to an office, a business, or other premises, may find the office door closed or the business door locked. The visitor is thus discouraged or prevented from communicating face-to-face with the occupant(s) of the office or business. Use of administrative assistants, security guards, identification card readers, office-hour signs, notes on doors indicating the status of the occupant, intercom systems, and the like, or even knocking by the visitor, ameliorate the problem somewhat. A better solution is for the visitor to call or instant-message the occupant(s), e.g., on the visitor's cell phone. But this results in a real-time two way communication only if the occupant is willing to be interrupted by the call and answer it immediately, as opposed to allowing the call to go to voice mail.

### SUMMARY OF THE INVENTION

According to one aspect of the invention, there is provided an entryway communication client device or system that enables a visitor to a premises to communicate with an occupant of the premises in real time, but in a way that is less intrusive than face-to-face communications such as voice communications—namely, via visual communications such as icons and text. The client device is located in proximity to the entryway to the premises, and comprises a user-interface and a display screen. The client device is connected, or adapted for connection, to a communication server that implements a presence service for the occupant and provides presence information about the occupant to the device. The device displays the provided presence information on its display screen and provides information entered by the visitor via its user interface to the server. The server displays the entered information to the occupant.

This manner of communicating with the visitor is much less intrusive on and disruptive to the occupant than a voice communication. Hence, there may be no situation, except for the occupant not being present on the premises, where as little (none) communication occurs as if the visitor were to knock on the entryway and receive no answer. Consequently, the visitor's visit is not in vain even if the visitor does not get to speak with the occupant.

The invention may be implemented both as a method and an apparatus, as well as a computer-readable medium containing instructions which, when executed by a computer, cause the computer to perform the method.

### BRIEF DESCRIPTION OF THE DRAWING

These and other features and advantages of the invention will become more apparent from considering the following description of an illustrative embodiment of the invention together with the drawing, in which:

FIG. 1 shows premises that include an illustrative embodiment of the invention;

FIG. 2 is a block diagram of a client device of the premises of FIG. 1;

FIG. 3 is a block diagram of a server of the premises of FIG. 1;

FIG. 4 shows an illustrative image displayed by the client device of FIG. 2;

FIG. 5 shows an illustrative image displayed by the server of FIG. 3; and

FIG. 6 is a flowchart showing illustrative use of an entryway communication system of the premises of FIG. 1.

### DETAILED DESCRIPTION

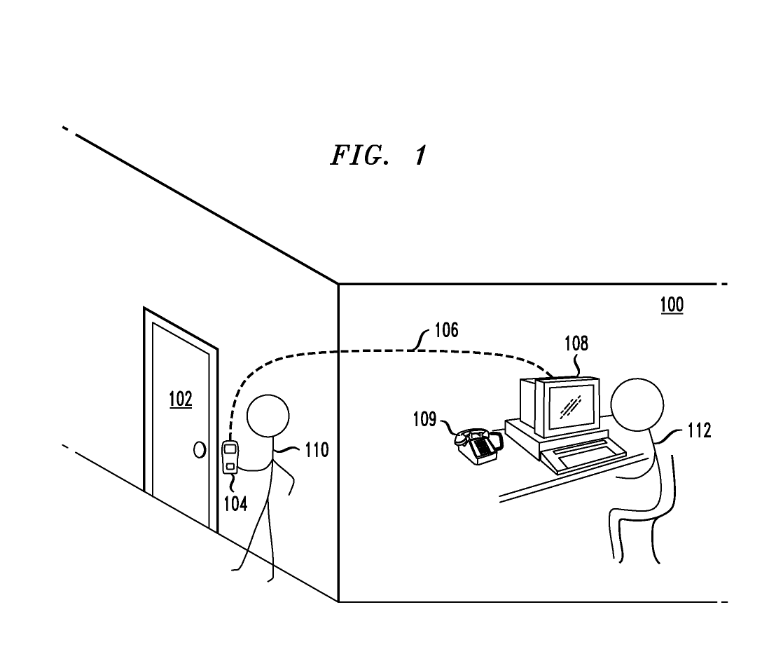

FIG. 1 shows premises 100 equipped with a communications system that comprises a client device 104 located near an entryway 102 to premises 100 and connected to a server 108. Premises 100 may be any desired premises, such as an individual office, a business, a residence, etc. If entryway 102 is an outdoor entrance, device 104 is weather-proofed. When a visitor 110 drops by premises 100 intending to speak with occupant 112 of premises 100, but finds entrance 102 to be closed or locked, visitor 110 uses device 104 to find out the status (“presence”) of occupant 112 and to appraise occupant 112 of the physical presence of visitor 110 at entrance 102 and of the purpose of the visitor's visit.

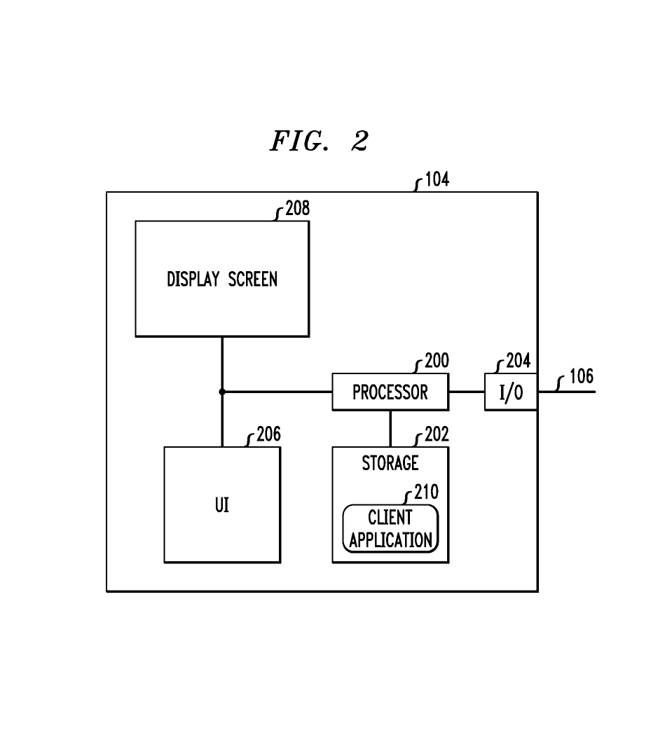

Connection 106 is any desired wired or wireless communications connection. For example, connection 106 may be an instant messaging (IM) connection. Device 104 is shown in more detail in FIG. 2. It is illustratively a stored-program controlled device comprising storage 202 for storing programs 210 and data, a processor 200 for executing programs from storage 202, an input/output (I/O) 204 such as a communications port for communicatively connecting device 104 to server 108 via connection 106, a display screen 208, and a user interface (UI) 206 such as a keyboard, a touch-sensitive screen, and/or a point-and-click device. For example, device 104 may comprise a cellular telephone, a personal digital assistant (PDA), or a tablet personal computer. Device 104 may be mounted on a wall of premises 100.

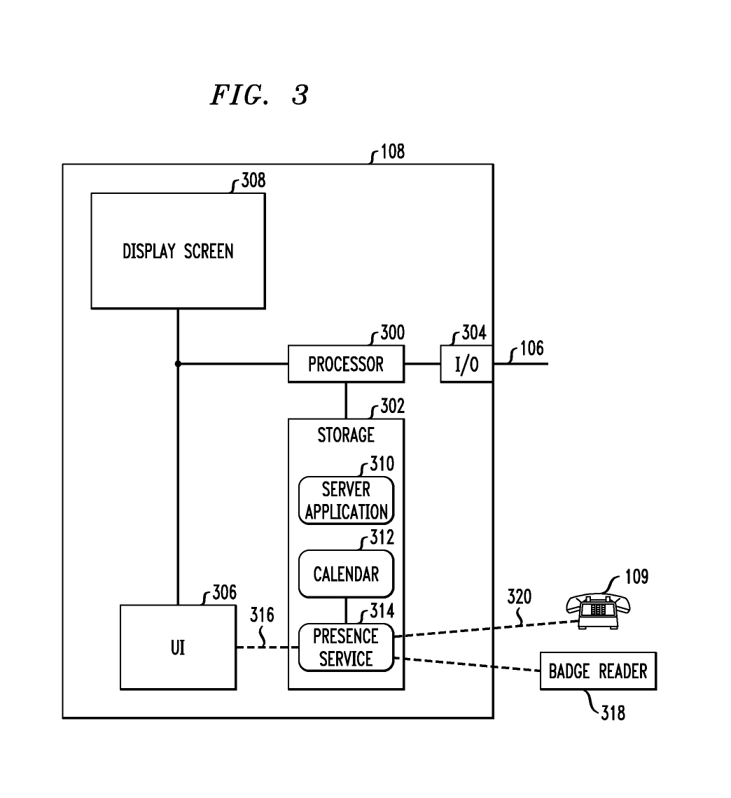

Server 108 is shown in more detail in FIG. 3. Server 108 is likewise a stored-program controlled device that comprises storage 302 for storing programs 310-314 and data, a processor 300 for executing programs from storage 302, an input/output (IO) 304 for connecting server 108 to connection 106, a display screen 308, and user interface (UI) 306. For example, server 108 may be a personal computer or a workstation of occupant 112. Alternatively, server 108 may comprise a user device akin to device 104 and a separate host computer that interfaces the two user devices. Server 108 implements a conventional presence service 314 for occupant 112. For this purpose, server 108 has access to sources of presence information regarding occupant 112, such as the occupant's on-line calendar 312, current telephone-status source 320, current personal-computer-status source 316, on-premises badge reader 318, etc. Additionally, occupant 112 may manually enter their presence status into server 108. The manual entry may either override or supplement the presence status that is automatically determined by the presence service 314. Presence service 314 creates and maintains a presentity representing occupant 112, and device 104 is subscribed as a watcher to the presentity, in a conventional manner.

If premises 100 are shared by a plurality of occupants 112, server 108 provides a presence service 314 for each occupant 112, and device 104 indicates the presence of whichever occupant 112 is selected by visitor 110 through interaction with device 104.

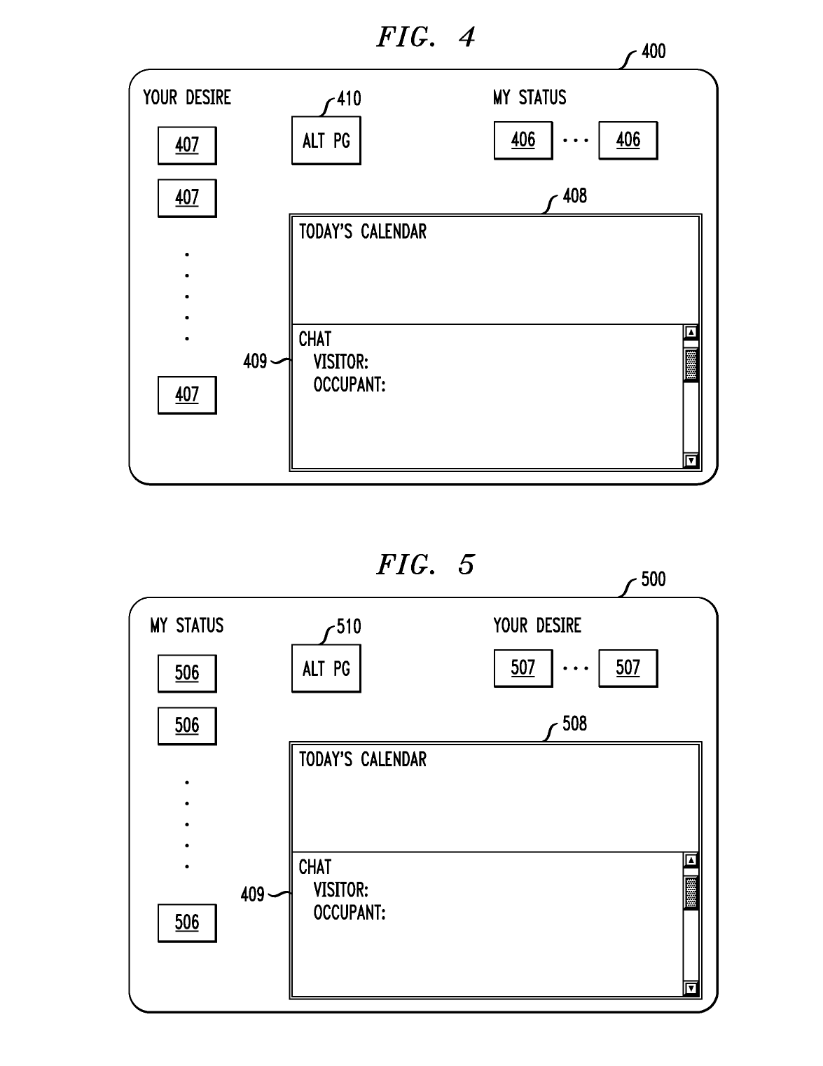

FIG. 4 shows a sample image 400 that is displayed on display screen 208 of device 104 according to one aspect of the invention. Image 400 presents one or more status icons 406 that represent current presence status of occupant 112, a plurality of task icons 407 that represent tasks that a visitor 110 may select, a calendar field 408 that shows calendar entries of occupant 112, a text field 409 that presents a chat interface between visitor 110 and occupant 112 showing the visitor's text entries and the occupant's text responses, and an “alternative page” icon 410 the selection of which by visitor 110 causes alternative pages or child views to be displayed as images on display screen 208. The location of icons 406, 407, and 410 and of fields 408 and 409 on display screen 208 is not important—they may be located anywhere as desired. Icons 406, 407, and 410 may be elaborated or simplified depending on cost, context (e.g., type of business, number of occupants, etc.), or other factors (type of applications for calendar, presence, etc.). Calendar field 408 shows a simplified—sanitized—version of the occupant's calendar, such as merely indicating a time and whether the occupant is “busy-in office”, “busy-out of office”, or “free” at that time, without giving details. Status icons 406 may represent status such as “do not disturb”, “knock and come in”, “on phone”, “in a meeting”, “please wait”, “time delay”, “pick a time to meet”, etc. Task icons 407 may represent tasks such as “Can we talk?”, “Amount of time needed?”, “We have a scheduled meeting—shall we postpone?”, “criticality of visit”, “topic(s)”, “visitor's identity”, “business or personal visit”, “let's chat”, etc. Other icons 407 may be specific to particular premises 100, such as to a residence or to a type of business being conducted on premises 100. Some icons 406 and 407 may come pre-programmed as generally-useful icons, while other icons 406, 407 may be created by occupant 112 to customize image 400 to the occupant's particular needs.

Substantially the same image 500 is illustratively presented to occupant 112 on server 108, as shown in FIG. 5, but with icons 407 and 408 reversed, such that icons 506 show all icons 406 selectable by occupant 112, and icons 507 shown icons 407 selected by visitor 110. Furthermore, image 500 may show the occupant's full calendar 508, as opposed to the sanitized version 408 thereof. When a visitor 110 begins to use device 104, an alerting icon such as a small version of image 500 may pop up on a display screen 308 of server 108 to alert occupant 112 to the visitor's presence. When occupant 112 selects that alerting icon, a full-size version of image 500 is displayed to occupant 112.

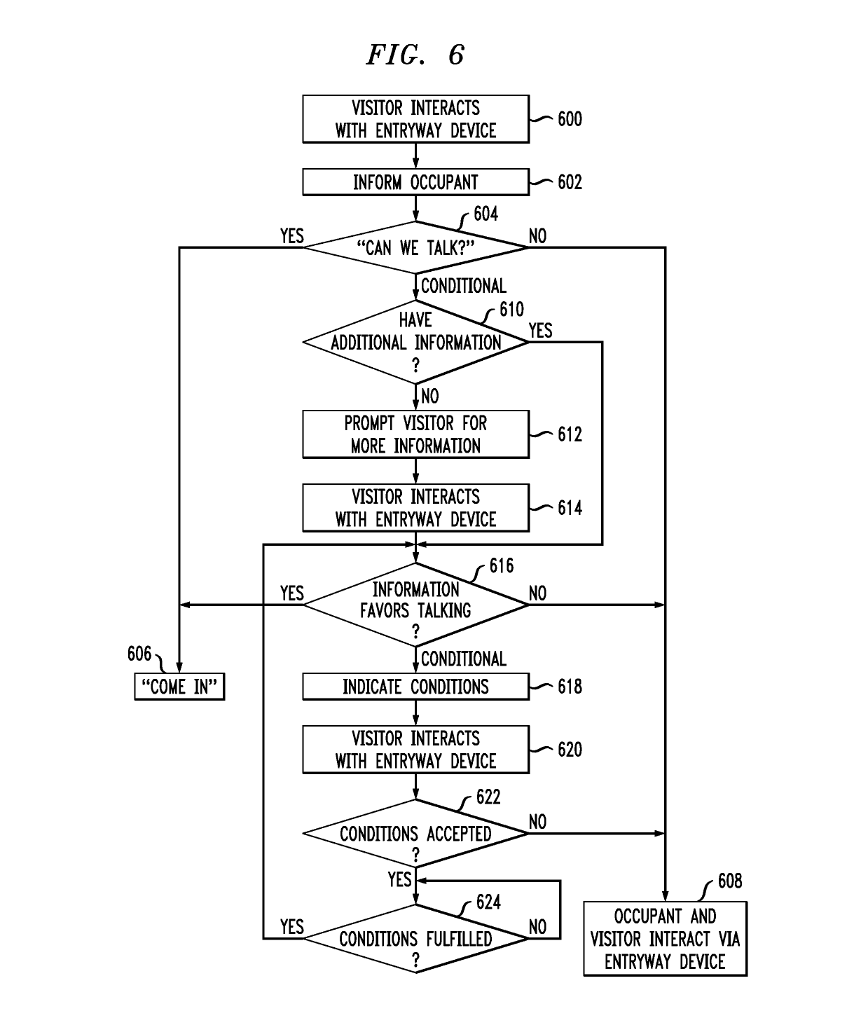

FIG. 6 illustrates use of the communication system of premises 100. When visitor 110 arrives at premises 100 and first interacts with device 104, such as by selecting one or more icons 407 or entering text in chat field 409, at step 600, occupant 112 is notified and presented with the visitor's input, at step 602. For example, a pop-up is displayed to occupant 112 on display screen 308 of server 108, and when occupant 112 selects the pop-up, server 108 displays image 500 highlighting the selected icon(s) 407 or showing the inputted text. At step 604, occupant 112 determines if visitor 110 selected “Can we talk?” icon 407 or inputted similar text. If so, and if occupant 112 decides to talk to the visitor 110 at this time, occupant 112 selects a “come in” icon 506 in image 500. This icon 506 is displayed to visitor 110 as an icon 406 in image 400 on device 104, at step 606. If visitor 110 selected “Can we talk?” icon 407 or inputted similar text but occupant 112 decides not to talk to visitor 110 at this time, or if visitor 110 did not select “Can we talk?” icon 407 and did not input similar text, visitor 110 and occupant 112 interact via device 104 (and server 108), at step 608, to, for example, schedule a meeting, arrange a drop-back time, or answer the visitor's question. If visitor 110 selected “Can we talk?” icon 407 or inputted similar text, but occupant 112 has not yet decided whether or not to talk to visitor 110, occupant 112 considers other information that visitor 110 may have provided, such as other icons 407 selected by visitor 110 or textual information input by visitor 110, to determine whether or not to meet with visitor 110, at step 616. For example, occupant 112 may need to ascertain the topic of desired conversation, the amount of time needed for the conversation, and the criticality of the subject, before deciding whether or not to talk to visitor 110. If visitor 110 did not provide sufficient additional information, as determined at step 610, occupant 112 prompts visitor 110 via device 104 to provide the additional information, at step 612, and visitor does so via device 104, at step 614. If occupant 112 determines at step 616 that the additional information, such as the time, topic, and/or criticality, favor talking to the visitor, occupant 112 invites visitor 110 to come in, at step 606. If talking is not favored at step 616, occupant 112 and visitor 110 proceed to interact via device 104, at step 608. If occupant 112 is conditionally willing to talk to visitor 110, occupant 112 indicates the conditions to visitor 110, at step 618. A condition may be, for example, “Can you wait five minutes?”. Visitor 110 responds to the conditions via device 104, at step 620. If visitor 110 does not accept the conditions, as determined at step 622, the interaction of occupant 112 and visitor 110 proceeds to step 608. If visitor 110 accepts the conditions, as determined at step 622, and when the conditions are fulfilled, as determined at step 624, occupant 112 returns to step 616 to determine if anything has changed in the meantime, e.g., has a critical phone call arrived, to change the occupant's decision to meet with visitor 110. If nothing has changed, occupant 112 proceeds to step 606 to meet with visitor 110.

Of course, various changes and modifications to the illustrative embodiment described above will be apparent to those skilled in the art. For example, device 104 may be supplemented with a camera or a biometric detector that helps occupant 112 ensure that visitor 110 is who they say they are. Or, device 104 could be a PDA or other device that user 110 might carry with them, and when user 110 arrives at the door, they could be signaled via a tone or vibration that a user interface is available for load to their device via IRDA port or equivalent. Another variation is that an IRDA port could be resident on device 104 that could in turn transmit a future meeting to the user's device (PDA or similar) via the IRDA port. These changes and modifications can be made without departing from the spirit and the scope of the invention and without diminishing its attendant advantages. It is therefore intended that such changes and modifications be covered by the following claims except insofar as limited by the prior art.

What is claimed is:

1. A system comprising:
a client communication device located in proximity to an entryway of a premises and comprising a user interface and a display screen;
a communication server communicatively connected to the client communication device, for implementing a presence service for an occupant of the premises and for providing presence information about the occupant to the communication device;
the communication device adapted for displaying the provided presence information on the display screen and for providing to the server information entered via the user interface by a visitor; and
the server adapted for displaying the entered information to the occupant.

2. The system of claim 1 wherein:
the presence information comprises at least one of whether the occupant is present on the premises, whether the occupant is busy or free, whether the occupant may or may not be disturbed, and calendar information of the occupant.

3. The system of claim 2 wherein:
the device is adapted to display the presence information to the visitor via at least one of icons, an on-line text chat field, and a calendar display field.

4. The system of claim 3 wherein:
the server is adapted to provide to the device icons selected by the occupant for display to the visitor.

5. The system of claim 1 wherein:
the information entered by the visitor comprises at least one of an identity of the visitor, a purpose of the visit, and a type of interaction with the occupant desired by the visitor.

6. The system of claim 5 wherein:
the server is adapted to display the entered information to the occupant via at least one of icons and an on-line text chat field.

7. The system of claim 6 wherein:
the device is adapted to provide icons selected by the visitor to the server for display to the occupant.

8. A method comprising:
providing a client communication device in proximity to an entryway of a premises, the device comprising a user interface and a display screen;
providing a communication server connected to the device;
providing a presence service for an occupant of the premises;
the server providing presence information about the occupant from the presence service to the device;
the device responding to receipt of the provided presence information by displaying the received presence information on the display screen to a visitor of the premises;
the device responding to entry by the visitor of information via the user interface by providing the entered information to the server; and
the server responding to receipt of the provided information entered by the visitor by causing the received information to be displayed to the occupant.

9. The method of claim 8 wherein:
the presence information comprises at least one of whether the occupant is present on the premises, whether the occupant is busy or free, whether the occupant may or may not be disturbed, and calendar information of the occupant.

10. The method of claim 9 wherein:
the device is adapted to display the presence information to the visitor via at least one of icons, an on-line text chat field, and a calendar display field.

11. The method of claim 10 wherein:
the server is adapted to provide to the device icons selected by the occupant for display to the visitor.

12. The method of claim 8 wherein:
the information entered by the visitor comprises at least one of an identity of the visitor, a purpose of the visit, and a type of interaction with the occupant desired by the visitor.

13. The method of claim 12 wherein:
the server is adapted to display the entered information to the occupant via at least one of icons and an on-line text chat field.

14. The method of claim 13 wherein:
the device is adapted to provide icons selected by the visitor to the server for display to the occupant.

15. An apparatus comprising:
a communications device having a display screen and a user interface, the device being adapted for mounting in proximity to an entryway to a premises and for connection to a communications link, the device being adapted to respond to receipt via the communications link of presence information about an occupant of the premises by displaying the presence information on the display screen, and further being adapted to respond to entry of information via the user interface by a visitor of the premises by providing the entered information via the communications link for displaying to the occupant.

16. The apparatus of claim 15 wherein:
the presence information comprises at least one of whether the occupant is present on the premises, whether the occupant is busy or free, whether the occupant may or may not be disturbed, and calendar information of the occupant.

17. The apparatus of claim 16 wherein:
the device is adapted to display the presence information to the visitor via at least one of icons, an on-line text chat field, and a calendar display field.

18. The apparatus of claim 17 wherein:
the icons comprise icons selected by the occupant for display to the visitor.

19. The apparatus of claim 15 wherein:
the information entered by the visitor comprises at least one of an identity of the visitor, a purpose of the visit, and a type of interaction with the occupant desired by the visitor.

20. The apparatus of claim 19 wherein:
the device is adapted to transmit the entered information to a display of the occupant.

21. The apparatus of claim 19 wherein:
the icons comprise icons selected by the visitor for display to the occupant.
